(19) United States
(12) Patent Application Publication
(10) Pub. No.: US 2019/0140282 A1
(43) Pub. Date: May 9, 2019

(54) METHOD FOR SYNTHESIZING ADDITIVE OF LITHIUM BATTERY AND CATHODE THEREOF

(71) Applicant: National Taiwan University of Science and Technology, TAIPEI CITY (TW)

(72) Inventors: Fu-Ming WANG, TAIPEI CITY (TW); Quoc-Thai PHAM, TAIPEI CITY (TW); Chorng-Shyan CHERN, TAIPEI CITY (TW); Yen-Jung HSU, TAIPEI CITY (TW)

(21) Appl. No.: 16/027,390

(22) Filed: Jul. 5, 2018

(30) Foreign Application Priority Data
Nov. 3, 2017 (TW) 106138184

(51) Int. Cl. H01M 4/62; H01M 10/0525; H01M 4/13; H01M 4/36; H01M 10/42; C08G 73/10; C08G 73/06

(52) U.S. Cl. CPC H01M 4/628; H01M 10/0525; H01M 4/13; H01M 2004/028; H01M 10/4235; C08G 73/1003; C08G 73/0633; H01M 4/366

(57) ABSTRACT

The present disclosure provides an additive of a lithium ion battery. The additive is an oligomer prepared by mixing maleimides and thiobarbituric acid and reacting the mixture of maleimides and thiobarbituric acid at 80° C.-130° C. for 0.5-24 hours. The present disclosure also provides a cathode of the lithium battery with the additive. The additive is 0.5-10 wt % based on the total weight of the cathode active material and the additive.

### CROSS-REFERENCE TO RELATED APPLICATION

This application claims priority to Taiwan Application Serial Number 106138184, filed Nov. 3, 2017, which is herein incorporated by reference in its entirety.

### BACKGROUND

### Field of Invention

The present invention relates to a lithium battery. More particularly, the present invention relates to a lithium battery with an additive.

### Description of Related Art

Lithium batteries are the novel batteries developed in recent years, which have the advantages of high energy density, low self-discharge, long cycle life and no memory effect. Also, the lithium batteries are environmentally friendly.

Nowadays, owing to the accidents in the event of explosion of the lithium batteries, the safety of the batteries has been taken more seriously by people. Due to the high energy density of the lithium batteries, it would produce considerable heat or even explode while being situated at extreme environment. One of the reasons causing the accidents mentioned above is that the cathode material collapses and releases oxygen, which makes the reaction more violent at high temperature. Accordingly, a solution for improving safety of the lithium batteries is needed.

### SUMMARY

One aspect of the present disclosure is to provide a method for manufacturing an additive of a lithium battery, the method includes mixing a maleimide and a thiobarbituric acid in a solvent to form a mixture, in which a molar ratio of the maleimide to the thiobarbituric acid is from 2:1 to 1:1; and reacting the mixture to form an oligomer.

In accordance with an embodiment of the method of the present disclosure, the maleimide is monomaleimide or bismaleimide.

In accordance with an embodiment of the method of the present disclosure, the monomaleimide includes N-phenylmaleimide, N-(ortho-methylphenyl)-maleimide, N-(meta-methylphenyl)-maleimide, N-(para-methylphenyl)-maleimide, N-cyclohexylmaleimide, maleimidophenol, maleimidobenzocyclobutene, phosphorus-containing maleimide, phosphoric maleimide, siloxy maleimide, N-(tetrahydropyranyl-oxyphenyl)-maleimide, 2,6-xylylmaleimide or a combination thereof.

In accordance with an embodiment of the method of the present disclosure, the bismaleimide includes a structure of

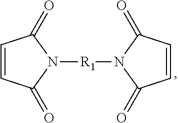

wherein R₁ comprises —(CH₂)₂—, —(CH₂)₆—, —(CH₂)₈—, —(CH₂)₁₂—,

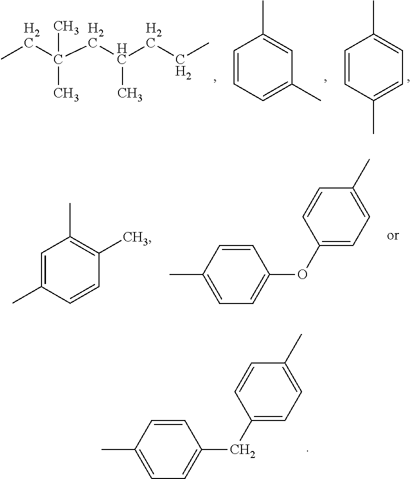

In accordance with an embodiment of the method of the present disclosure, the solvent includes N-methyl-2-pyrrolidone.

In accordance with an embodiment of the method of the present disclosure, in which reacting the mixture to form the oligomer is performed in an environment at a temperature of 80° C.-130° C.

In accordance with an embodiment of the method of the present disclosure, a duration of reacting the mixture to form the oligomer is 0.5-24 hours.

One aspect of the present disclosure is to provide a cathode of a lithium battery, including an oligomer. The oligomer including a structure of

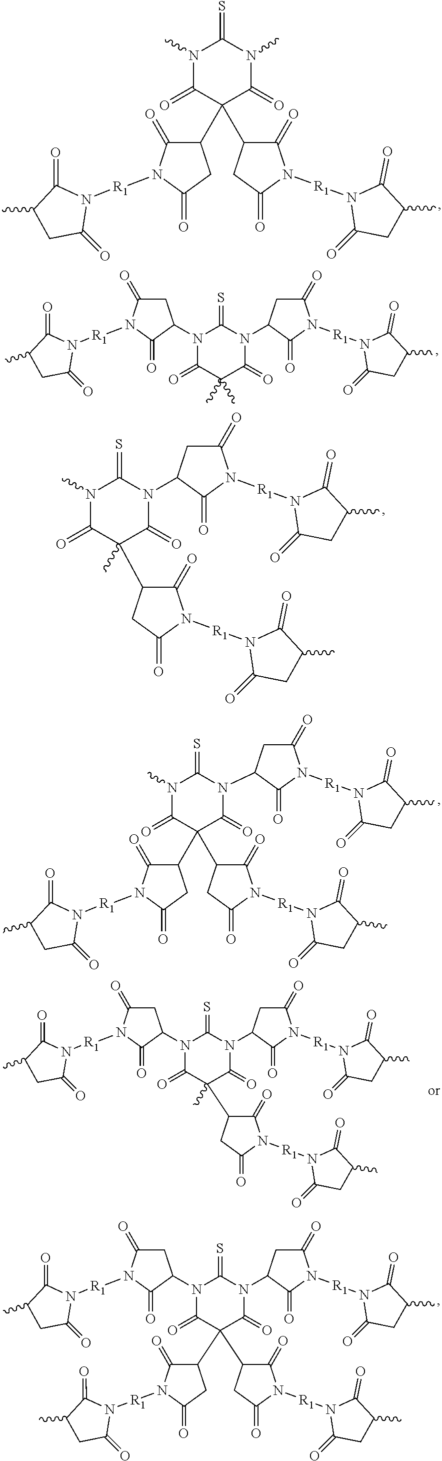

in which R₁ includes —(CH₂)₂—, —(CH₂)₆—, —(CH₂)₈—, —(CH₂)₁₂—,

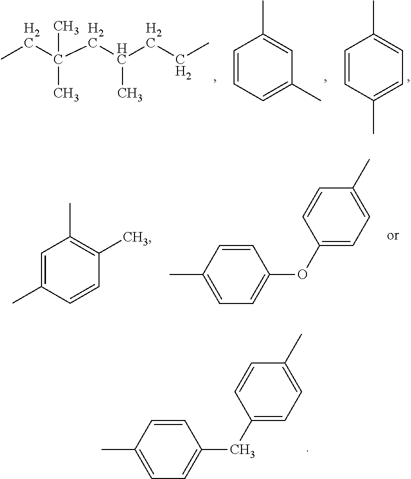

In accordance with an embodiment of the cathode of the lithium battery of the present disclosure, the cathode of the lithium battery includes a cathode active material, a conductive material, an adhesive and a conductive substrate, in which the adhesive, the cathode active material, the conductive material and the adhesive are disposed on the conductive substrate.

In accordance with an embodiment of the cathode of the lithium battery of the present disclosure, a weight percentage of the additive is 0.5 wt %-10 wt % based on the total weight of the cathode active material and the additive.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a graph showing constant current charge and discharge characteristics at room temperature of the lithium batteries;

FIG. 2A-2B illustrates current-voltage graphs of cyclic voltammetry (CV); and

FIG. 3 illustrates a graph of differential scanning calorimetry (DSC) test.

### DETAILED DESCRIPTION

Reference will now be made in detail to the present embodiments of the invention, examples of which are illustrated in the accompanying drawings.

The singular terms in the present disclosure include plural referents unless expressly stated. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “in an embodiment” or the like in various places throughout this specification are not necessarily referring to the same embodiment of the invention. Furthermore, the particular features, structures, configurations, or characteristics may be combined in any suitable manner in one or more embodiments.

Generally, the material of cathode structure in a lithium battery may collapse and release oxygen due to the collapse of the lattice when being operated at high temperature. The oxygen diffuses to every part of the lithium battery through the electrolyte. The electrolyte and the anode material in the lithium battery may be oxidized by the oxygen, resulting in the degradation of electrical properties. Additionally, the oxygen may induce a violent oxidation reaction or even an explosive oxidation reaction if the reaction keeps occurring in the high temperature environment.

The present disclosure provides an oligomer as an additive that can improve safety of the lithium battery for the purpose of solving the foregoing problem.

The raw materials for synthesizing the oligomer are maleimides and thiobarbituric acid (TBA).

The method for synthesizing the additive of the lithium battery includes forming a mixture of maleimides, thiobarbituric acid and a solvent, in which the molar ratio of the maleimides to the thiobarbituric acid is in a range from 2:1 to 1:1 according to some embodiments in the present disclosure. The weight ratio of the maleimides and the thiobarbituric acid together to the solvent is in a range from 5:95 to 20:80, such as 10:90 or 15:85, in certain embodiments. The mixture is placed in a reactor and reacted to form an oligomer in some embodiments. The reactor may be round-bottom flask, for example. The solvent may be N-methyl-2-pyrrolidone in some embodiments. It is noted that the reaction rate can be increased by using basic solvents.

The maleimides may be monomaleimides or bismaleimides (BMI) in some embodiments.

The monomaleimides may include N-phenylmaleimide, N-(ortho-methylphenyl)-maleimide, N-(meta-methylphenyl)-maleimide, N-(para-methylphenyl)-maleimide, N-cyclohexylmaleimide, maleimidophenol, maleimidobenzocyclobutene, phosphorus-containing maleimide, phosphoric maleimide, siloxy maleimide, N-(tetrahydropyranyl-oxyphenyl)-maleimide, 2,6-xylylmaleimide or a combination thereof.

In some embodiments, the bismaleimides may include a structure of formula (i):

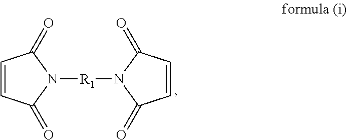

in which R₁ includes —(CH₂)₂—, —(CH₂)₆—, —(CH₂)₈—, —(CH₂)₁₂—,

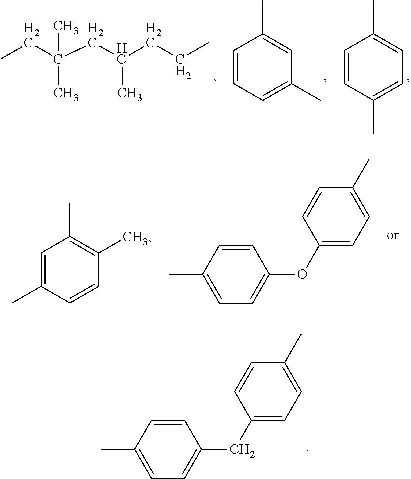

In some embodiments of the present disclosure, the thiobarbituric acid may include a structure of formula (ii) below:

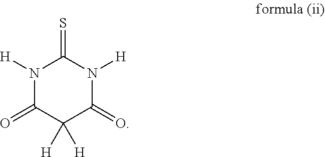

The reaction of the mixture of the maleimides and the thiobarbituric acid includes Michael addition reaction and free-radical addition reaction. It is noted that the hydrogen atom connected to the carbon atom in the thiobarbituric acid is replaced first during the reaction due to the relatively lower activation energy of the hydrogen atom. In some embodiments, the hydrogen atoms connected to the carbon atoms in the thiobarbituric acid are replaced. In other embodiments, the hydrogen atoms connected to the carbon atoms and the hydrogen atoms the nitrogen atoms are replaced.

The structure of the oligomer in the present disclosure may vary according to the parameters of the reaction process. Some exemplary structures of the oligomer are illustrated hereinafter.

In some embodiments, the reaction product of the maleimides and the thiobarbituric acid may include a structure of formula (iii) below, in which R₁ may be the same as R₁ of the bismaleimides mentioned above.

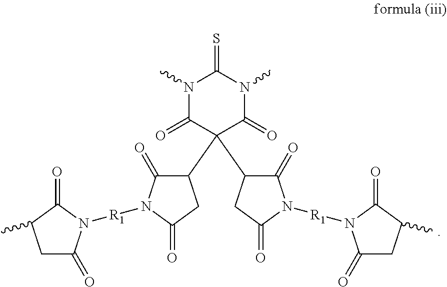

In some embodiments, the reaction product of the maleimides and the thiobarbituric acid may include a structure of formula (iv) below, in which R₁ may be the same as R₁ of the bismaleimides mentioned above.

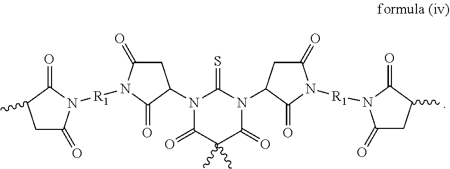

In some embodiments, the reaction product of the maleimides and the thiobarbituric acid may include a structure of formula (v) below, in which R₁ may be the same as R₁ of the bismaleimides mentioned above.

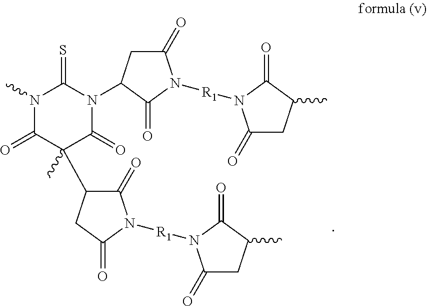

In some embodiments, the reaction product of the maleimides and the thiobarbituric acid may include a structure of formula (vi), in which R₁ may be the same as R₁ of the bismaleimides mentioned above.

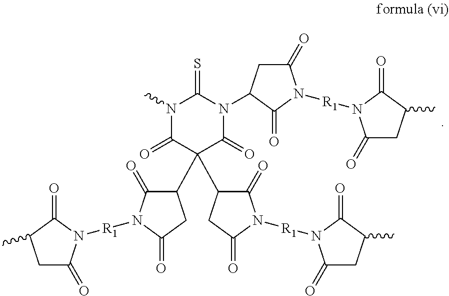

In some embodiments, the reaction product of the maleimides and the thiobarbituric acid may include a structure of formula (vii), in which R₁ may be the same as R₁ of the bismaleimides mentioned above.

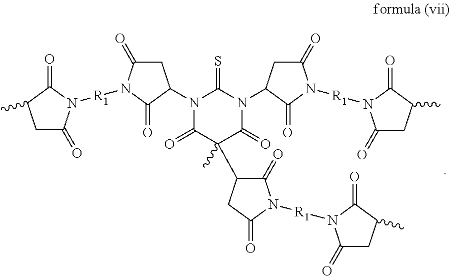

In some embodiments, the reaction product of the maleimides and the thiobarbituric acid may include a structure of formula (viii), in which R₁ may be the same as R₁ of the bismaleimides mentioned above.

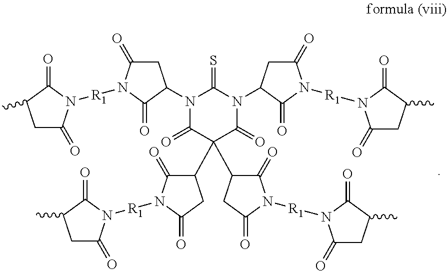

The each symbol “ [symbol] ” in formula (iii)-(viii) represents any chemical structure that can be connected with, such as hydrogen or the structures of formula (iii)-(viii).

The mixture is reacted to form the oligomer at about 80° C. to about 130° C., such as 90° C., 100° C., 110° C. or 120° C., in some embodiments. The hydrogen atoms connected to the carbon atoms and the hydrogen atoms connected to the nitrogen atoms in the thiobarbituric acid are all replaced at high temperature in accordance with certain embodiments. The more hydrogen atoms in the thiobarbituric acid are replaced, the higher degree of crosslinking the formed oligomer is. High degree of crosslinking may induce a reticulated structure, which may improve the electric properties of the lithium battery. In other words, the electrical properties and safety of the lithium battery are associated with the degree of crosslinking of the oligomer.

In certain embodiments, the mixture is reacted for about 0.5 hour to about 24 hours to form the oligomer in certain embodiments, such as 1, 2, 5, 10, 15 or 20 hours. The duration of the reaction depends on the temperature. A desired degree of crosslinking may be achieved by choosing appropriate temperature and duration of the reaction. Generally, if the duration of the reaction is too short, such as less than 0.5 hour, the improvement of the electric properties and safety of the lithium battery would be insignificant due to the molecular weight of the formed oligomer being too small and the degree of crosslinking being too low. If the duration of the reaction is too long, such as greater than 24 hours, the degree of crosslinking of the formed oligomer would become too high, which results in difficulties of processing. Further, high degree of crosslinking would also affect the uniformity of the electrode slurry and the electric properties of the lithium battery.

In a comparative Example A, a mixture of the maleimides and the barbituric acid was reacted at 100° C. for 2 hours. In an Embodiment A, a mixture of the maleimides and the thiobarbituric acid was reacted at 100° C. for 2 hours. Table I is the gel permeation chromatography (GPC) data of Comparative Example A and Embodiment A. It is noted that the retention times of both Comparative Example A and Embodiment A exceed the range of the calibration curve in the measurement, therefore the weight-average molecular weights and the poly dispersity indexes in Table I are merely relative value.

TABLE I

| | weight-average | poly dispersity |
|---|---|---|
| | molecular weights | indexes |
| Comparative Example A | 118,514,461 | 4,591 |
| Embodiment A | 62,216,094 | 4,214 |

The product obtained from the reaction of the mixture of the maleimides and the thiobarbituric acid mentioned above may be used as an additive for the lithium battery in some embodiments. The additive may be the cathode additive in some embodiments. In certain embodiments, the cathode of the lithium battery includes the additive. In certain embodiments, the cathode of the lithium battery further includes cathode active material, conductive material, adhesive and conductive substrate, in which the cathode active material, the additive, the conductive material and the adhesive are disposed on the conductive substrate. By adding the oligomer to the cathode of the lithium battery, as the cathode additive, a heat-insulating polymer layer may be formed on the surface of the cathode, in which the heat-insulating polymer layer may protect the lithium battery and avoid the released oxygen from diffusion to the other parts of the battery when the cathode material structure collapses. In addition, the heat-insulating polymer layer may improve the diffusivity of the lithium ion in the battery and decrease the impedance of the battery.

In some embodiments, the cathode of the lithium battery includes cathode active material, conductive material, adhesive and the oligomer obtained from the reaction of the mixture of the maleimides and the thiobarbituric acid, in which the weight percentage of the oligomer is about 0.5 wt % to about 10 wt %, such as 1 wt %, 1.5 wt %, 2 wt %, 5 wt % or 8 wt %, based on the total weight of the cathode active material and the oligomer. If the weight percentage of the oligomer is too little, such as less than 0.5 wrt %, the improvement of the safety of the cathode would be insignificant. If the weight percentage is too large, such as greater than 10 wt %, the weight percentage of the cathode active material would decrease, which results in the decrement of the energy capacity of the battery.

The cathode active material may include lithium compound, such as lithium cobalt oxide, lithium nickel oxide, lithium manganese oxide, lithium iron oxide, or other compounds, according to some embodiments. The cathode active material may include lithium nickel cobalt manganese oxide (NCM), lithium nickel cobalt aluminium oxide (NCA), LiCoO₂, LiMn₂O₄, LiFePO₄, high voltage layered over-lithiuated oxides or high voltage spinel material in some embodiments.

The conductive material may include carbon black, graphite, carbon fiber or a combination thereof in certain embodiments. The carbon black may be acetylene black, super P carbon black, Ketjen black or a combination thereof. The graphite may be artificial graphite, natural graphite or a combination thereof. The carbon fiber may be vapor grown carbon fibers (VGCF).

In certain embodiments, the adhesive may include polyvinylidene difluoride (PVDF), polytetrafluoroethylene latex (PTFE) or polyacrylate (PAA).

The conductive substrate may be copper foil, aluminum foil or other metal foils, in which the copper foil may be rolled and annealed copper foil or electrodeposited copper foil.

The electrolyte of the lithium battery may include electrolyte solvent and lithium salt in certain embodiments. The electrolyte solvent may include organic solvent, such as ethylene carbonate (EC), propylene carbonate (PC), 1,2-dimethoxyethane (DME), dimethyl carbonate (DMC), tetraethylene glycol dimethyl ether (TEGDME), ethyl methyl carbonate (EMC), diethyl carbonate (DEC) or a combination thereof, in some embodiments. The lithium salt may include LiClO₄, LiPF₆, AsF₆Li, lithium bis(trifluoromethane)sulfonamide (LiTFSI) or a combination thereof in some embodiments.

All the electrical properties were measured with half-cells in the present disclosure. Lithium half-cell is a regular mean to evaluate the electrical properties of materials of the lithium battery. In the half-cell, the sample is working electrode, and the counter electrode and the reference electrode are lithium metal. The electrical properties of the sample were measured with lithium metal as a reference. In certain embodiments, the charge/discharge tests were measured in a manner of a coin cell.

In Embodiment 1 of the present disclosure, the bismaleimides and the thiobarbituric acid were mixed in the solvent and reacted at 100° C. for 18 hours to form an oligomer. The obtained oligomer was added into the cathode as an additive. A lithium half-cell was formed using the cathode, and the electric properties of which were measured, wherein the weight percentage of the oligomer was 1.5 wt % based on the total weight of the cathode active material and the oligomer. The cathode active material was NCA.

In Comparative Example 1, the bismaleimides and the barbituric acid were mixed in the solvent and reacted at 100° C. for 18 hours to form an oligomer. The oligomer was added into the cathode as an additive. A lithium half-cell was formed using the cathode, and the electric properties of which were measured, in which the weight percentage of the oligomer is 1.5wt % based on the total weight of the cathode active material and the oligomer. The cathode active material was NCA.

In Comparative Example 2, the cathode of the lithium battery did not include any additives, in which the cathode active material is NCA. In Comparative Example 3, the lithium battery did not include any electrolyte and the cathode of the lithium battery did not include any additives, wherein the cathode active material was NCA.

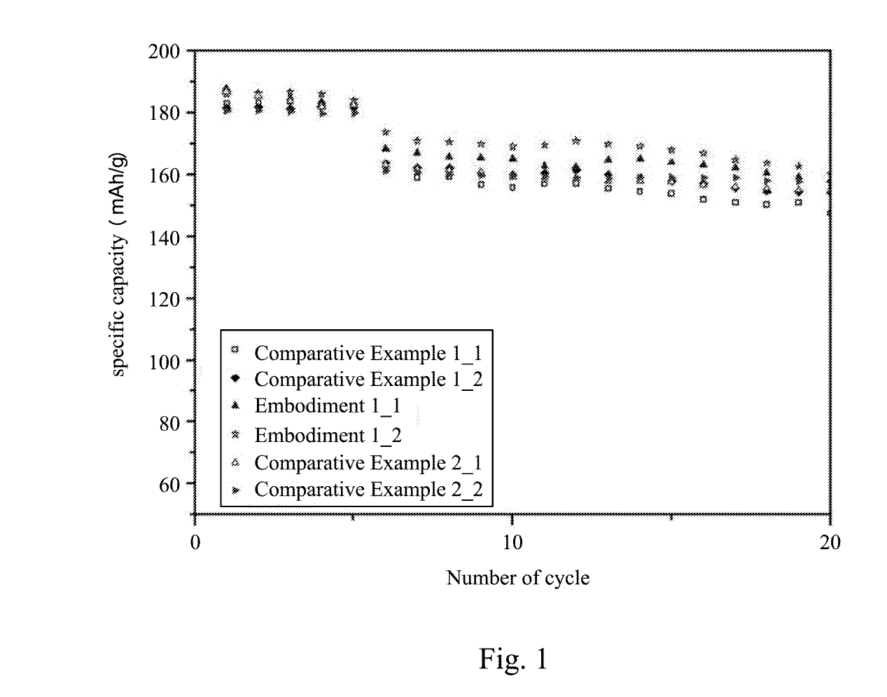

FIG. 1 illustrates a graph showing constant current charge and discharge characteristics, at room temperature, of the lithium batteries of Embodiment 1, Comparative Example 1 and Comparative Example 2. The current using in first five cycles is 0.1C, after that is 1C, in which C is a representation of current. 1C is defined as the current used to drain a battery within an hour, and 0.2C is the current used to drain the battery within five hours. For example, for a 100 mAh battery, 1C is 100 mA and 0.2C is 20 mA. In FIG. 1, Embodiment 1, Comparative Example 1 and Comparative Example 2 are repeated twice to verify the reliability. For example, “Embodiment 1_1” indicates the first experiment of Embodiment 1, and “Embodiment 1_2” indicates the second experiment of Embodiment 1. As show in FIG. 1, the specific capacity of Embodiment 1 (i.e., with oligomer obtained from the bismaleimides and the thiobarbituric acid) is better than Comparative Example 1 and Comparative Example 2. More particularly, the data of the two experiments of Embodiment 1 is better than Comparative Example 1 and Comparative Example 2. In addition, the difference in the specific capacity between Comparative Example 1 and Comparative Example 2 is not significant. Besides, the specific capacity of Comparative Example 2 (i.e., without any additive) is greater than that of Comparative Example 1 at 1C current. In other words, the specific capacity of Embodiment 1 is greater than Comparative Example 1 and Comparative Example 2 no matter at low current cycle such as 0.1C, or at high current cycle such as 1C. Using the oligomer synthesized from the maleimides and the thiobarbituric acid as the additive of the lithium battery can enhance the diffusivity of the lithium ion in the battery, which lowers the impedance caused by the diffusion and improves the specific capacity.

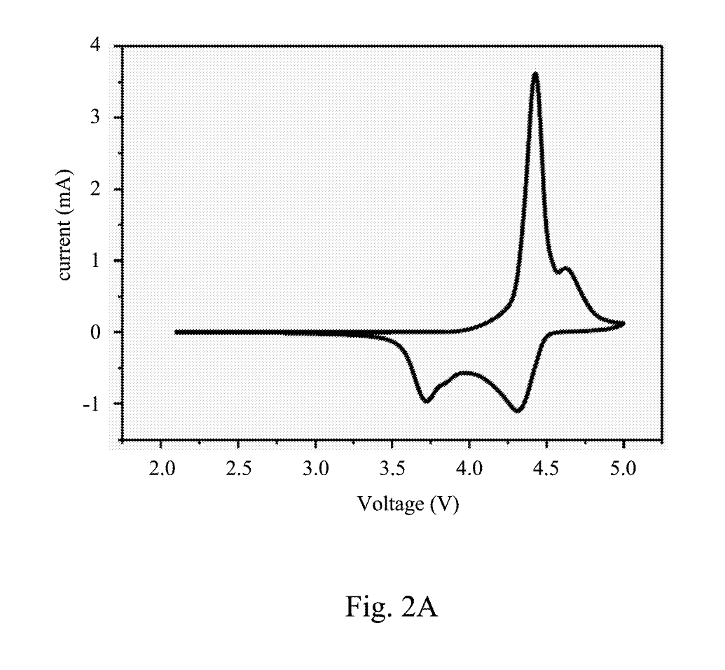

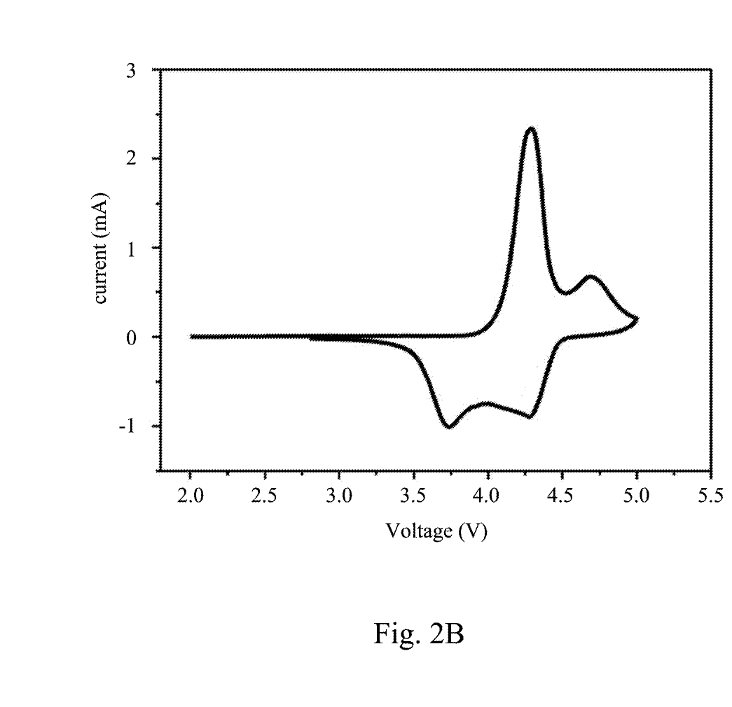

FIG. 2A illustrates a current-voltage graph of cyclic voltammetry (CV) of Comparative Example 1, in which the scan rate is 0.2 mV/s. The oxidation peak of cobalt ion in FIG. 2A is about 4.5V. FIG. 2B illustrates a current-voltage graph of cyclic voltammetry (CV) of Embodiment 1, in which the scan rate is 0.2 mV/s. The oxidation peak of cobalt ion in FIG. 2B is about 4.3V. It is noted that the oxidation potential of cobalt ion in Embodiment 1 is less than Comparative Example 1, thus the activation energy in Embodiment 1 is relatively lower. The additive provided in the present disclosure can effectively improve the diffusivity of lithium ion in the battery and lower the impedance. In addition, the two oxidation peaks in Embodiment 1 are separated, and the oxidation peaks in Comparative Example 1, by contrast, are overlapped with each other, which shows that there is only a single reaction and no other side reactions when cobalt ion is oxidized in Embodiment 1. A single reaction may improve long cycle life and the specific capacity after a long cycle.

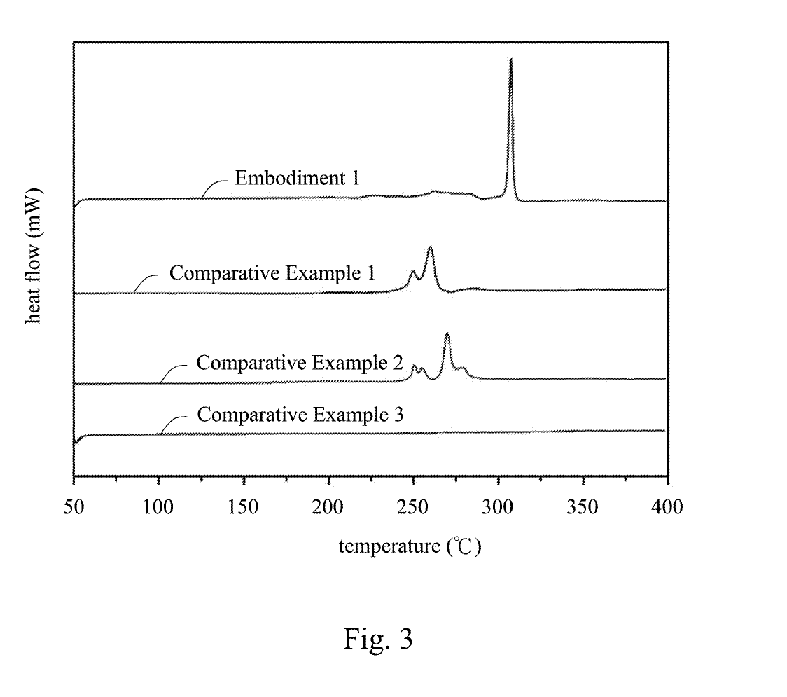

FIG. 3 illustrates a graph of differential scanning calorimetry (DSC) experiments for each of the Embodiments and Comparative Examples, in which each experiment was performed by heating to 400° C. from a room temperature at a heating rate of 3° C./min. The samples tested in DSC were fully charged cathodes. As shown in FIG. 3, Comparative Example 2 begins to release heat at about 140° C., and the main exothermic region is in the range between about 250° C. and about 280° C. Comparative Example 1 begins to release heat at about 180° C., and the main exothermic region is at about 250° C. Embodiment 1 begins to release heat at about 220° C., and the main exothermic region is at about 310° C. The temperature of main exothermic region in Embodiment 1 is significantly higher than those in Comparative Example 1 and Comparative Example 2. In other words, the cathode of the battery adding the additive provided in the present disclosure has a significantly higher temperature at which the cathode occurs a violent exothermic chain reaction. It is believed that the additive of Embodiment 1 may form a heat-insulating polymer layer on the surface of the cathode material so to prevent the oxygen from diffusing, and that significantly reduces the possibility and the risk of exploding. Besides, it is noted that there is no main exothermic region in Comparative Example 3 due to the absence of the electrolyte, which shows that the exothermic reaction in cathode at high temperature requires the involvement of electrolyte.

The additive provided in the present disclosure may form a heat-insulating polymer layer on the surface of the cathode active material when the battery is operated or situated in an extreme condition. Even the structure of the cathode material collapses and releases oxygen, the heat-insulating polymer layer prevents the oxygen from diffusing to the whole battery, that effectively avoids the following chain reactions, and therefore the safety of the battery is improved.

The heat-insulating polymer layer formed by the additive provided in the present disclosure can prevent the micro short circuit between the cathode and the anode, and can avoid excessive current which induces considerable heat. In typical lithium battery, a separator is disposed between the cathode and the anode to prevent the short-circuit due to the contact of the cathode with the anode. The separator, however, may shrink at a high temperature. Once the separator shrank, the cathode may be in contact with the anode, which induces short-circuiting and producing considerable heat. The electrolyte of the lithium battery may be vaporized and reacted rapidly at high temperature because the electrolyte includes organic solvent. The vaporized organic solvent may induce the combustion of the battery or even explosion. Accordingly, the size of the separator needs to be greater than the size of the cathode and the anode. Although the greater size of the separator would make the battery safer, the volume of the battery also increases, which leads to a decrease of the energy density. The size of separator may be decreased by adding the additive provided in the present disclosure into the cathode of the lithium battery because the heat-insulating polymer layer formed by the additive may prevent the instant heavy current when short-circuited. Consequently, the additive may improve the energy density while maintaining the safety of the battery.

The additive provided in the present disclosure may be added into the anode or the electrolyte to improve the safety of the battery.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for manufacturing an additive of a lithium battery, the method comprising:
mixing a maleimide and a thiobarbituric acid in a solvent to form a mixture, wherein a molar ratio of the maleimide to the thiobarbituric acid is from 2:1 to 1:1; and
reacting the mixture to form an oligomer.

2. The method of claim 1, wherein the maleimide is monomaleimide or bismaleimide.

3. The method of claim 2, wherein the monomaleimide comprises N-phenylmaleimide, N-(ortho-methylphenyl)-maleimide, N-(meta-methylphenyl)-maleimide, N-(para-methylphenyl)-maleimide, N-cyclohexylmaleimide, maleimidophenol, maleimidobenzocyclobutene, phosphorus-containing maleimide, phosphoric maleimide, siloxy maleimide, N-(tetrahydropyranyl-oxyphenyl)-maleimide, 2,6-xylylmaleimide or a combination thereof.

4. The method of claim 2, wherein the bismaleimide comprises a structure of 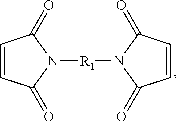
wherein R₁ comprises —(CH₂)₂—, —(CH₂)₆—, —(CH₂)₈—, —(CH₂)₁₂—,

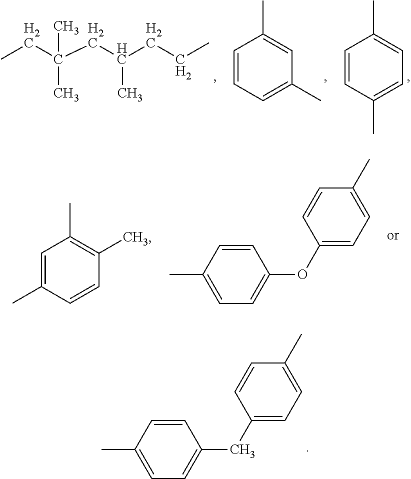

5. The method of claim 1, wherein the solvent comprises N-methyl-2-pyrrolidone.

6. The method of claim 1, wherein reacting the mixture to form the oligomer is performed in an environment at a temperature of 80° C.-130° C.

7. The method of claim 1, wherein a duration of reacting the mixture to form the oligomer is 0.5-24 hours.

8. A cathode of a lithium battery, comprising:
an oligomer, comprising a structure of 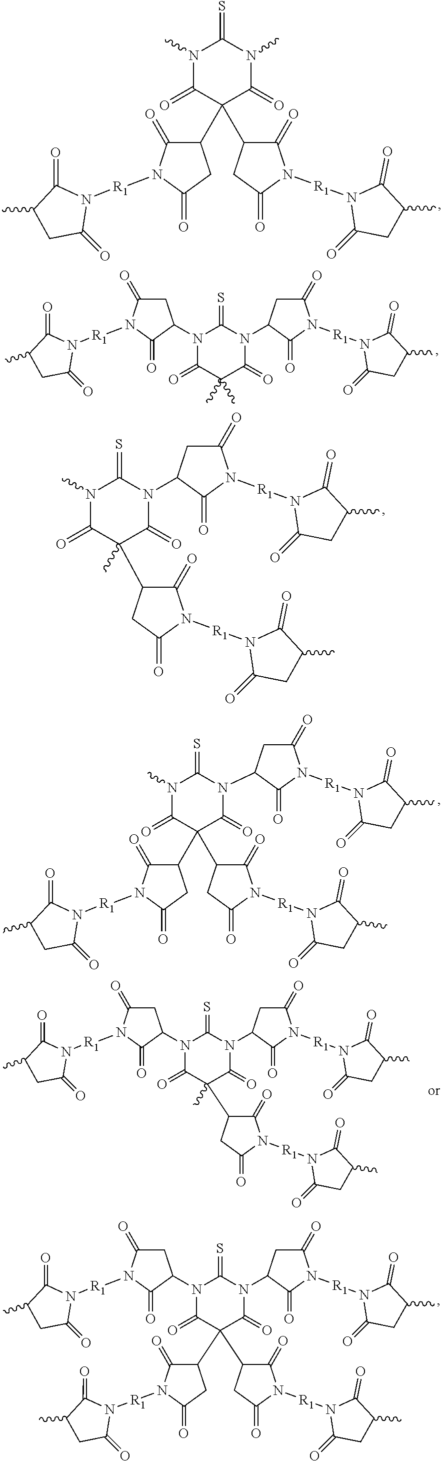
wherein R₁ comprises —(CH₂)₂—, —(CH₂)₆—, —(CH₂)₈—, —(CH₂)₁₂—,

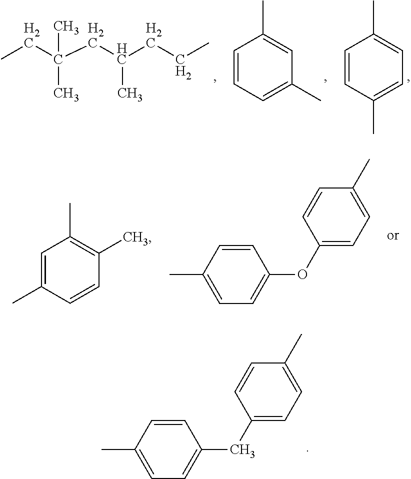

9. The cathode of the lithium battery of claim 8, further comprising:
a cathode active material;
a conductive material;
an adhesive; and
a conductive substrate, wherein the adhesive, the cathode active material, the conductive material and the adhesive are disposed on the conductive substrate.

10. The cathode of the lithium battery of claim 8, wherein a weight percentage of the oligomer is 0.5 wt %-10 wt % based on the total weight of the cathode active material and the oligomer.
